(19) United States
(12) Patent Application Publication
(10) Pub. No.: US 2005/0242602 A1
(43) Pub. Date: Nov. 3, 2005

(54) Crane hook with remotely operated safety latch release

(76) Inventor: Edward R. Protesto, Newtown Square, PA (US)

Correspondence Address: Robert B. Famiglio, Esquire;FAMIGLIO & ASSOCIATES, P.O. Box 1999, Media, PA, 19063, US

(21) Appl. No.: 11/117,089

(22) Filed: Apr. 28, 2005

Related U.S. Application Data
(60) Provisional application No. 60/566,145, filed on Apr. 28, 2004.

(51) Int. Cl. B66C 1/36

(52) U.S. Cl. 294/82.21

(57) ABSTRACT

A hook mechanism for use with a lifting crane or other lifting apparatus which provides for a safety latch mechanism is disclosed. The hook provides a latching mechanism to prevent accidental or unintentional release of a load, lifting cable or line being held by the hook. The latch mechanism secures the throat of the hook and remains engaged to prevent disengagement of a line being lifted until such release is desired. The latch mechanism is remotely releasable by use of a manually operated release line or in a preferred embodiment a remotely controlled wireless release mechanism. The safety latch element of the hook contains a spring mechanism to provide for automatic opening upon release of the latch by the remote means.

### CROSS REFERENCES TO RELATED APPLICATIONS

The Applicant claims the benefit of his U.S. provisional patent application Ser. No. 60/566,145 filed on Apr. 28, 2004.

### BACKGROUND OF THE INVENTION

1. Field of the Invention

The present invention relates to load lifting apparatus such as hooks normally used with cranes or other hoisting tackle or equipment. The disclosed crane hook mechanism includes safety equipment which prevents premature release of the load or the ropes, chains, or other straps used to secure a load to the hook. The safety release mechanism is remotely controllable, either through a manual release cable extending some distance from the hook, or a wireless remote control system. All embodiments of the invention provide for positive release of the safety enclosure mechanism only when desired.

2. Description of the Related Art

Lifting devices and other apparatus used at the end of a lifting crane or other load bearing line are well developed in the prior art. Snap hooks, crane hooks, and other lifting apparatus are generally comprised of a hook shank which extends from the point of attachment of the hook to a load bearing line, down through an appropriate angle and a leading tip of the hook to form the shape to capture a chain, or other load bearing line secured to a load to be lifted by the hook, using a crane or other load bearing apparatus. The opening of a hook shape is sometimes referred to as the throat or mouth.

There are a plethora of different hook designs which are employed in various applications, whether it be marine, industrial, or general categories of crane hooks for lifting loads or to affix the crane's load bearing line to a load to be lifted. The load or load bearing line is placed onto the hook through the throat of the hook.

In operation of cranes generally, in moving a load, occasionally the load being lifted contacts the ground or other object. It is possible for the load to become disengaged from the hook unintentionally, as striking an object may cause the load or the separate line attaching the load to the hook to “bounce” off of the load bearing hook and disengage through the throat of the hook. This event then requires reengagement and also creates an obvious safety hazard.

It is desirable to affix the load to the hook once the load is secured on the hook through the throat to prevent the disengagement of the load from the hook until desired by the operator of the crane or a crew managing conveyance of the load. It is particularly important to prevent the premature disengagement of the lifting lines or of the load when the load is in a dangerous area or is near workers who are guiding the load to its desired position.

The operator of the crane attached to the hook sometimes jogs the load to place the load in a specific targeted position before disengaging the hook from the load. Jogging is an operation to move a crane or trolley crane bridge in a series of short, discontinuous increments by momentary operation of a controller normally accomplished at the end of a lifting cycle to place a load in a precisely targeted resting point after conveyance of the load over a larger distance. Frequently, when jogging the hook, the load being suspended will bounce off of the ground or other structures as it is finally moved into its desired position before release of the lifting apparatus. Premature or unintended release of loads or lifting straps affixed to loads occurs most frequently at this point in the operation of the apparatus, causing a hazardous condition to property and personnel in the immediate area.

The bouncing or vibration of the load caused by jogging may cause the lift straps, the load resting on the hook, or other load bearing lines to be momentarily disengaged from the load bearing portion of the hook, sometimes bouncing back out of the throat area of the hook, thereby causing complete disengagement of the load. In that regard, in the past various catch mechanisms or spring hooks have been developed for the purpose of requiring that a specific operation occur before release of the load from the hook such as to prevent accidental disengagement through the throat of the hook or to otherwise be sure that the load is not disengaged until the user manipulates the latching mechanism to disengage the load. Existing devices require direct manipulation of a hook mounted safety latch to release the load.

In crane lifting operations, to expedite matters and to prevent as little inconvenience or time delay as possible, it would be desirable to have any safety latch closing off the throat of the load bearing hook to be releasable from a remote position without the need to lower the crane hook to a ground level or otherwise provide access to the hook to release the safety by direct manipulation of any safety device locking the load to the hook.

There are various mechanisms demonstrated in the prior art which allow manual release of a self-locking hook from a standoff position, but such devices have not been satisfactorily applied to a load bearing hook for lifting heavy loads such as with a crane or other load lifting apparatus. Moreover, there are no simple, fail-safe means to accomplish the results desired or the needs expressed by experienced users of such equipment. A safety latch release mechanism capable of being released with a simple extension cable is needed. The prior art also does not disclose a remotely releasable safety catch mechanism for a load bearing hook which can be of a wireless design and therefore not require the extension or protrusion of any remote release cables being manipulated by ground personnel by physically actuating such a release cable.

### SUMMARY OF THE INVENTION

The disclosed invention is an improved load bearing crane hook which provides for a safety latch mechanism to prevent disengagement of the load being lifted by the hook until a positive command is provided by one or more operators engaged in the process. The basic embodiment provides a load bearing crane hook in a more or less conventional modified “U” shape, but which also includes a pivoting member with a machined barrel latch bolt activated by a spring mechanism. The pivoting or moveable member closes the throat of the hook when set in position.

The spring mechanism provides positive engagement between the barrel latch bolt and the tip of the hook, such as to provide a closed line or load engagement area and prevent accidental release of the load from the hook. The barrel latch driven by a spring behind the latch or coaxially with the bolt provides positive engagement of the safety member in closing or preventing accidental dislodgement of the load bearing line. Upon application of tension on a cable attached to the barrel latch bolt, the barrel latch bolt retracts and the safety element pivots around a point driven by a spring means or counterweight providing positive movement to the open position upon release of the latch.

In a preferred embodiment, the cable releasing the barrel latch bolt is replaced by an electric solenoid and a remote control receiver allowing activation of the release mechanism without a connecting cable. In such a wireless environment, the solenoid is commanded by a battery powered wireless receiver to retract a cable attached to the barrel latch, both elements being within the safety member. When commanded to retract the latch or bolt, the member rotates about a pivot point driven by a spring, counterweight, or other forcing means which creates torque or which provides the rotational force necessary to automatically open the safety member upon desired release of the member through a pull of the release line or activation of the wireless receiver control means. A remote control transmitter and receiver are employed which use conventional digital encoding techniques to provide safety and security, thereby preventing accidental release from stray radio frequency signals or unintended activation of the safety release by momentary activation of a release switch.

Accordingly, it is the object of the present invention to provide an improved crane hook for lifting loads which includes a safety latch to prevent disengagement of the load until the operator of the crane or load lifting system desires release of the load.

It is also the object of the present invention to provide such a safety latch for a load lifting hook which can be remotely released from a ground location or other convenient point by a person upon activation of tension of the release mechanism which releases and causes rotation of the safety member.

It is yet another object of the present invention to provide a safety latch mechanism for a load bearing hook which employs wireless means to command the safety latch and element to the open position upon activation of the control signal to do so.

It is further an object of the present invention to provide a mechanism to secure the throat of a crane hook to prevent disengagement of the load from the hook until it is desired to release the load by removing a member closing the throat of the hook by causing selectable release and thereafter automatic movement of the safety member upon command of the operator.

### BRIEF DESCRIPTION OF THE DRAWINGS

FIG. 1 is a side plan view of the invention utilizing a manual release mechanism presenting the basic components and a ghosted view of the internal latch release mechanism.

FIG. 2 is a side plan view of the invention utilizing a wireless remote control solenoid release mechanism presenting the basic components and a ghosted view of the internal latch release mechanism.

FIG. 3 is a side plan view of the present invention illustrating the manual release embodiment of the hook in an open position.

FIG. 4 is a side plan view of the present invention illustrating a wireless control embodiment of the crane hook in the open position.

FIG. 5 is an end plan view of the invention illustrating the details of the rotating arm utilized in the invention.

FIG. 6 is a prospective close-up view of the latching mechanism including the manual bolt release attached thereto.

FIG. 7 is a pictorial illustration of a typical wireless remote control transmitter device to be used with the preferred embodiment utilizing a remote bolt release control solenoid.

FIG. 8 is a side plan view of a preferred embodiment of the invention in which the solenoid which retracts the latching bolt is located in the rotating arm of the hook.

FIG. 9 is a prospective view of a preferred embodiment shown in FIG. 8.

### DETAILED DESCRIPTION OF THE INVENTION

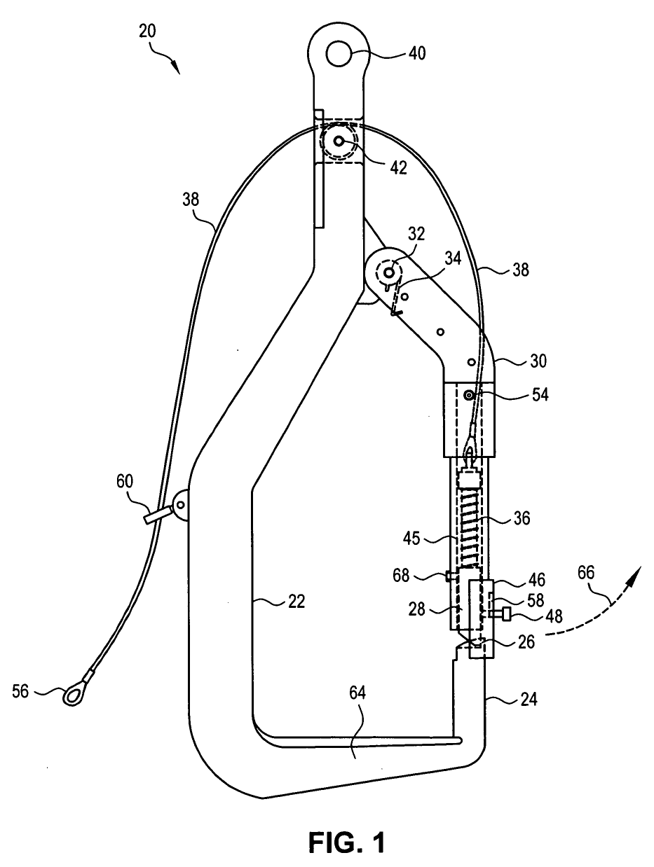

And now the invention will be described in reference to the various figures wherein like-numerals refer to like-parts. The basic embodiment of the present invention is shown in FIG. 1. FIG. 1 is a side view of the manual embodiment of the load lifting hook. The manual release version of crane hook 20 is comprised of a basic hook body extending from hook support eye 40, downward through hook shank 22, and hook lower surface 64. To complete a load bearing area to capture a load securely, hook lower surface 64 continues to extend to hook mouth ledge 24 which defines the lower portion of the throat of hook 20.

In basic load bearing hooks, such as are normally used with cranes and other lifting apparatus, a load is placed onto lower surface 64 which is a portion of a hook which supports a load such as a beam, truss or other component, or may be used to support strapping or slings which themselves affixed to a load to be raised. With basic hook design it is desirable to keep the load or the load bearing straps or rigging from slipping off the hook lower surface 64, which surface is frequently comprised of a flange of sufficient width to prevent pinching or cutting into the load being lifted. Hook mouth ledge 24 extends upward from the hook lower surface 64 to capture either the load or the load bearing rigging and prevents the load from slipping off the hook in the normal course of the use of the hook.

The throat of a hook is normally defined as the area or length extension between hook mouth ledge 24 and the top of hook shank 22 as it extends upwards toward the hook support eye 40. In this regard, the hook throat may also be defined by the opening of the hook created by shank 22, lower surface 64 and mouth ledge 24. The present invention closes the area within the hook body by safety latch rotating arm 30 which is shown in FIG. 1 in a closed position, capturing the load or a load bearing sling placed on lower surface 64. Rotating arm 30 closes off the throat of the hook when set in the closed position.

In order to maximize safety and control release of the load on hook 20, it is desirable to allow rotating arm 30 to be affixed to mouth ledge 24 during operation of hook 20, but release and swing free of mouth ledge 24 when commanded to do so by the operator of the load lifting equipment or apparatus to which the hook is connected. The remote operation of rotating arm 30 is accomplished by a retraction spring 34 located concentrically to pivot axis 32 around which rotating arm 30 pivots describing the arc represented at 66 in FIG. 1. The spring bias contained in rotating spring 34 is enabled when the rotating arm 30 is placed in the closed position as shown in FIG. 1. The safety latch retracting bolt 28 is a latching mechanism which is captured by safety latch anchor 26 when retracting bolt 28 is in the downward or locked position as shown in FIG. 1.

Retracting bolt 28 is spring loaded in the down position through bolt spring 36 which holds bolt 28 in a position normally at rest which extends downward past latch anchor 26 and is therefore captured by same. Bolt housing shroud 45 is held in position with set screw 68. Shroud 45 is a housing for bolt 28. Bolt 28 is slidably inserted and disposed within shroud 45 such as to travel concentrically within said shroud causing spring tension by the compression of bolt spring 36 when bolt 28 is in the retracted position, sliding upward in FIG. 1.

Bolt 28 is also manually retractable using manual bolt retraction handle 48 which allows an operator to open arm 30 to place a load within hook 20. Handle 48 extends outward through retraction handle slot 58 as illustrated in the various figures. Handle 48 extends through slot 58 from bolt leading edge guard 46. Guard 46 is a shaped plate fixed to the bottom end of arm 30 which both stops further inward travel of arm 30 and prevents accidental disengagement of bolt 28 where it intersects to meet safety latch anchor 26. By extending downward over the intersection of bolt 28 and anchor 26, guard 46 prevents a line, object, or other material from unintendedly being engaged or forced through the bottom portion of the throat if the hook accidentally strikes an external object. A rope, line, ledge or other obstruction could possibly force bolt 28 in the upward position if the hook was traversing across a line or object which slipped between bolt 28 and anchor 26. By utilizing guard 46, the interface between the bottom leading edge of bolt 28 and latch anchor 26 can be protected from items or materials striking this area and possibly forcing the undesired opening of the hook by unintended retraction of bolt 28 without a command to do so. Guard 46 also contacts safety latch anchor 26 as shown in the various figures to arrest further inward movement of arm 30 when arm 30 is moved back into the closed position and bolt 28 is lined up with mouth ledge 24.

It is desirable to be able to selectively and remotely retract bolt 28 and have arm 30 thereby open, swinging upward as represented by arc 66 shown in FIG. 1. To accomplish this, bolt 28 is attached to manual bolt release cable 38 which travels from the rear of bolt 28 upward, passed release cable guide 54 to release cable pulley 42 as shown. Cable 38 continues around pulley 42 and is diverted in the downward direction, being held generally in place by cable release end guide 60. Guide 60 could be comprised of a pulley, or a wire guide with a capture mechanism as depicted to prevent release cable 38 from straying, possibly failing within the hook, the load being carried within the hook or otherwise fouling. Cable guide 60 allows release cable 38 to play cleanly down the edge of hook shank 22 and presents the release cable attachment loop 56 in a position where it is convenient to attach another cable, rope or line to allow the cable 38 to be pulled thereby retracting bolt 28 against spring 36. When cable 38 is retracted by application of tension on loop end 56, it can be appreciated that spring bias contained retraction spring 34 causes arm 30 to rotate upward as described.

In the various embodiments illustrated in the various figures, cable 38 is shown with considerable slack in the line for clarity. It can be appreciated by those skilled in the art that cable 38 would normally be resting closer to the body of hook 20 because of the weight of the line, and because of the line connected in attachment loop 56. Also, it is possible if desired to place cable 38 within a cable shroud such as a plastic tube where the ends of the tube are affixed to support positions located on the body of hook 20 thereby allowing cable 38 to traverse through such a protective shroud when in the vicinity of the hook itself. In operation, it has been determined that conventional stranded steel cable used for cable 38 is flexible, survives well exposed to the elements without shrouding or covers, and plays well through the various guides and pulleys without the need for unusual lubrication or guiding apparatus.

This described manual embodiment of the present invention allows a user on the ground to release the rotating arm 30 only when it is desired that the load being carried by lower surface 64 be released. In practice, loop end 56 can be affixed to a short rope of perhaps ten or twenty feet, depending on the actual application, such that personnel on the ground can access release cable 38 and place tension on same only when they are certain that the load is ready to be released and that arm 30 can be rotated away from the body of the hook, thereby allowing the hook to fall free from the load or straps bearing the load to be lifted over mouth ledge 24. An extension rope connected to attachment loop 56 is sized to allow access to it by a person at a stand-off position for a given application. The hook may remain above the ground at a height of many meters when release of the load is desired. Normally, the crane operator will lower the hook once the load is set in a desired position to place slack in the line attached to eye 40. This action facilitates the hook swinging free of the load when arm 30 is raised.

When hook 20 is ready to be placed back in service for the next lifting task, and after a new load has been applied or hook 20 is inserted within material to be lifted, arm 30 is rotated by application of force by hand back down to the closed position, whereby the lower edge of bolt 28, being inclined as shown, retracts the bolt momentarily when it contacts latch anchor 26 allowing the bolt thereafter to snap into the closed position after the outer edge of bolt 28 clears latch anchor 26.

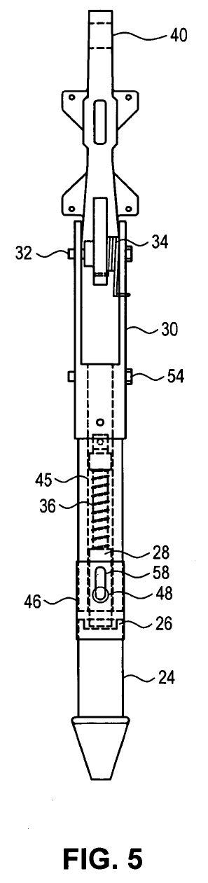

FIG. 5 depicts an end plan view of rotating arm 30 showing in ghosted view various of the components described above. The details of the top of arm 30 can be seen and FIG. 5 illustrates how arm 30 attaches to the safety arm pivot axis 32. Also, arm retraction spring 34 can be more clearly viewed from the aspect presented.

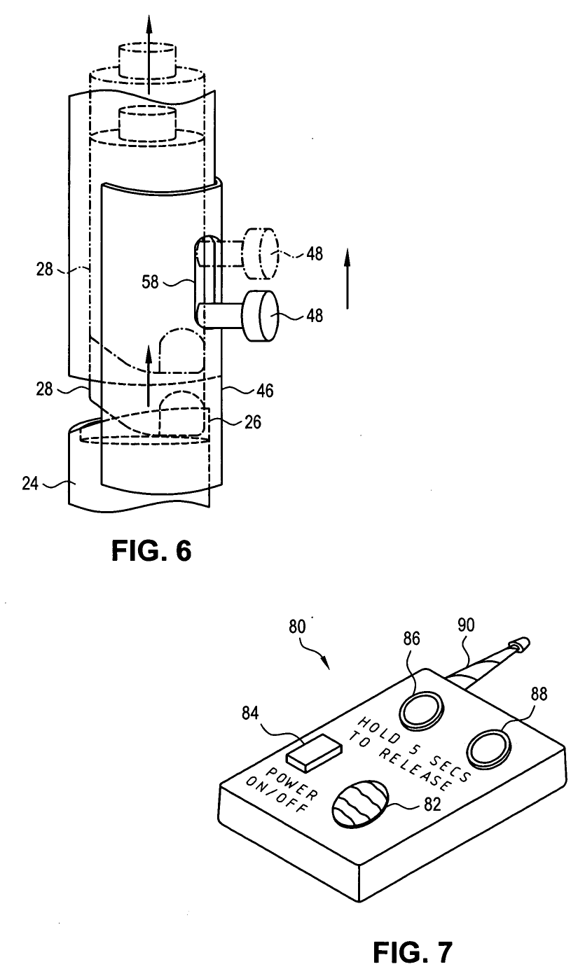

FIG. 6 is a close-up, ghosted view of bolt 28 showing the movement of the bolt in operation as it is displaced by application of retracting force from a cable or solenoid, and as it is returning to its resting, locked position upon release through the pressure of a spring, a solenoid, or gravity, as the case may be.

It can be appreciated by considering FIG. 1 that there are other methods which may be employed to cause the rotation of rotating arm 30 upon retraction of bolt 38 through the application of tension on cable 38. For example, rotating arm 30 may continue to extend passed pivot axis 32 and be loaded with a counterweight system which would present a moment about the axis 32 to replace the bias of spring 34. As can be seen, if such moment existed, release of bolt 28 would cause arm 30 to rotate upwards in the same fashion as described above when using spring 32.

It should also be appreciated that the inventions described in the various figures would operate in the fashion described above without the downward force applied to bolt 28 through spring 36. Spring 36 forces bolt 28 in a downward position when cable 38 is released. Bolt 28 is of sufficient mass such that bolt 28 would return to the downward position even without spring 36 in many applications. Cable 38 as shown in FIG. 1 is normally of insufficient mass to offset the mass of bolt 28. Of course, if a line attached to cable release attachment loop 56 is of sufficient weight, it may not allow bolt 28 to return to the downward position through use of gravity alone. Accordingly, it is preferred that hook 20 utilizes a spring 36 with sufficient spring tension to snap bolt 28 back in the downward position when any tension applied by cable 38 is released.

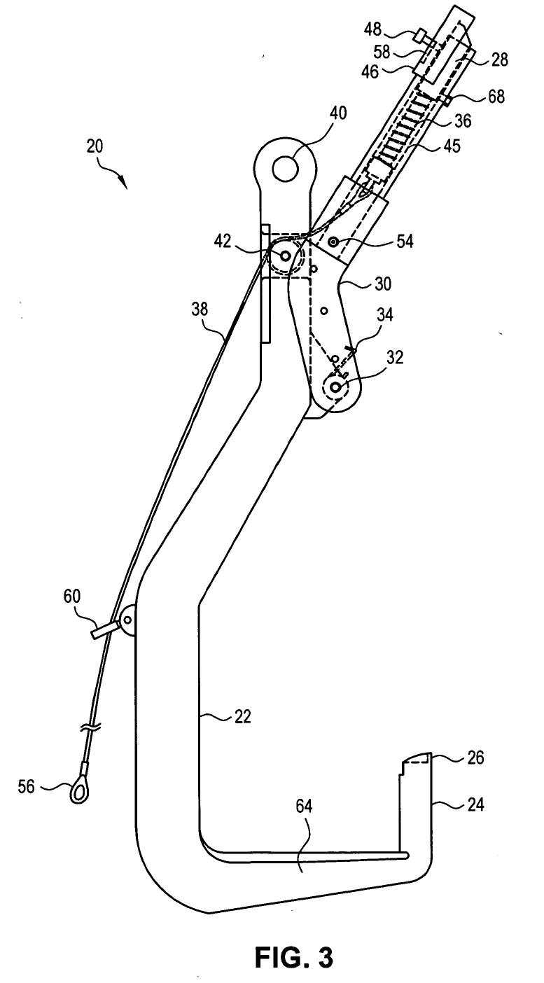

FIG. 3 is an illustration of hook 20 as shown in FIG. 1 in the open position. As will be appreciated, arm 30 is rotated in the open position, driven by spring 34 upon the retraction of bolt 28. To recycle hook 20, arm 30 is rotated down to the closed position shown in FIG. 1 by the application of simple hand pressure. When bolt 28 travels over latch anchor 26 which is on the tip of mouth ledge 24, the bolt snaps back into closed position and the hook has therefore been closed.

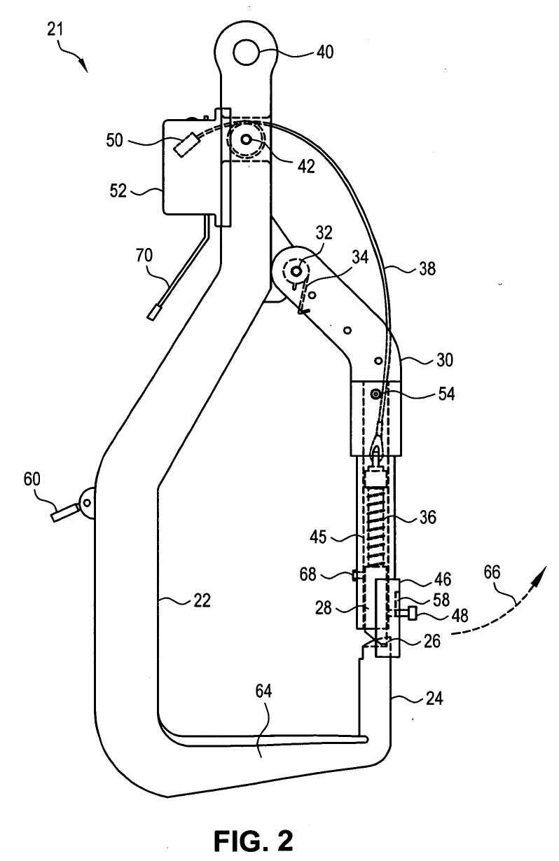

Turning now to FIG. 2, another embodiment of the present invention will be described. It should be appreciated that the embodiment disclosed in FIG. 2 is, in many respects, identical in the basic components and operations of the manual hook depicted in FIG. 1 except as described herein. Electric release hook 21 shown in FIG. 2 operates in a similar fashion as that described for hook 20 in FIG. 1. However, as can be seen by FIG. 2, cable 38 terminates inside wireless receiver unit 52. Wireless receiver 52 is a remote control receiver unit similar to those which may be used on automatic garage door openers and other appliances which employ short range wireless controllers to enable to disable one or more simple functions. Wireless receiver 52 is a battery operated receiver which receives signals through antenna 70 from a wireless remote control transmitter 80 device shown in FIG. 7. Receiver 52 provides battery power to itself and solenoid 50. Upon a signal command, receiver 52 activates and retracts solenoid 50. Solenoid 50 is an electrical solenoid device which, upon activation and the application of voltage across at the applicable solenoid terminals, causes retraction of bolt 28 by applying tension on release cable 38 through retraction of the cable. Similar to that operation described in the manual release hook 20 shown in FIG. 1, electric release hook 21 applies tension through cable release pulley 42 which guides cable 38 into the wireless receiver 52 as shown. Operation of electrical release hook 21 is similar to that of the manual hook as can be appreciated by comparing FIG. 1 with FIG. 2. Upon activation by transmitter 80, receiver 52 causes retraction of cable 38 by solenoid 50, thereby releasing bolt 28, retracting the bolt against spring 36 in a similar fashion as earlier described.

It should be appreciated that wireless receiver 52 and companion transmitter 80 can operate on a number of different frequencies as is well known to those skilled in the art of radio control equipment or wireless control generally. It is not necessary to have wireless apparatus which has a range of any greater than perhaps a hundred meters, more or less. This is because it is not desirable or necessary to have a remote release capability of hook 21 if the hook is not in visual range of the operator of the remote control unit. Likewise, it is possible to use infrared transmitters and receivers such as are presently applied to certain types of home entertainment equipment such as receivers or television devices. A wireless infrared control system does require that the hook be in direct line of sight of the operator using an infrared-type wireless transmitter to activate solenoid 50.

In either case, remote control transmitter 80 depicted in FIG. 7 should have a fail-safe operator interface so that inadvertent activation of a button on the remote activation unit does not cause premature release of arm 30 when it is not desired. In the preferred embodiment, the remote transmitter 80 requires activation of two separate buttons to complete the release command. There are several different ways to program or to set up the human interface of transmitter 80 to allow for fail-safe operation.

A first method is to require that first button 86 and second button 88 shown in FIG. 7 are simultaneously depressed for at least a predetermined number of seconds with a tone module 82 sounding to alert the operator that he has depressed both release buttons and should expect movement of arm 30 shortly. In the event that an activation of both buttons on the remote control simultaneously was inadvertent for some reason, release of any one button will discontinue the activation process thereby requiring reactivation of both buttons for the program delay period before the receiver 52 will cause retraction of solenoid 50 thereby freeing arm 30 to swing free.

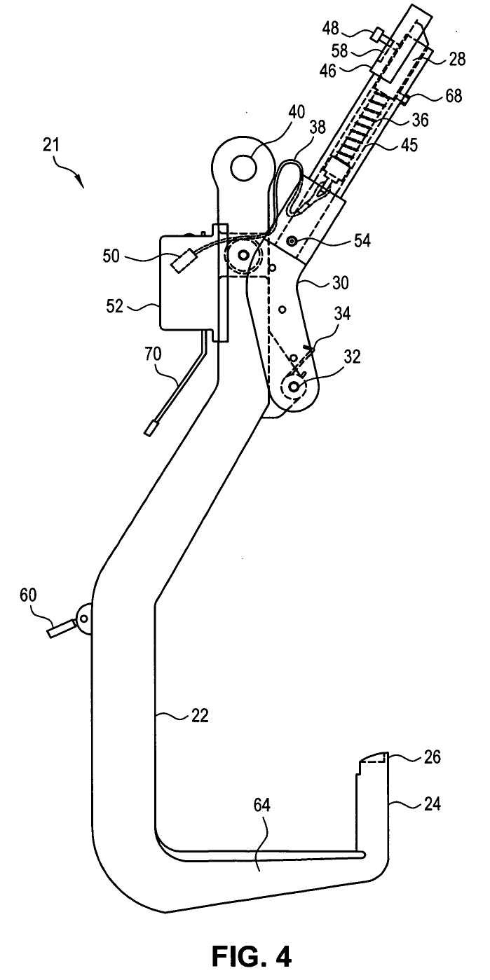

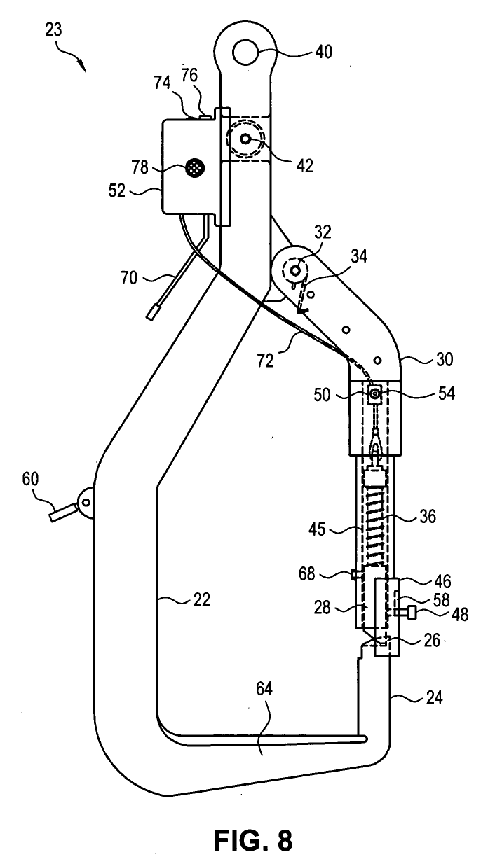

Turning to FIG. 4, it can be seen that the remote control hook 21 of FIG. 2 is shown in the open position. In this configuration of the hook, cable 38, which is of a fixed length, flexes upward under the compression caused by arm 30 rotating to the open position as shown. It should also be noted that the various configurations of the hook shown and described in the various figures can be retrofitted in the sense that hook 20 in FIG. 1 can become hook 21 in FIG. 2, or hook 23 as shown in FIG. 8, by retrofitting or changing the components necessary to make the manual hook into an automatic hook, or vice versa if desired. This is because the major components of the hooks shown in the various figures are essentially the same with respect to the operation of the common components of the hook design.

It is also possible to configure transmitter 80 to require sequential execution of commands. In the preferred embodiment, first switch 86 is depressed to arm receiver 52. Upon arming receiver 52 module 82 emits an intermittent beeping alerting the operator that the system has been armed and that selection or depression of second switch 88 will cause activation of the mechanisms engaging the safety latch. If second switch 88 is not depressed within a predetermined amount of time after first switch 86 has been depressed, the system returns to an unarmed status. Either method provides a fail-safe human interface. In the preferred embodiment it has been determined that operators prefer one-handed operation and therefore a sequential selection pattern requiring depression of switch 86 first to arm the system, and then depression of second switch 88 to release the load.

Transmitter 80 includes power switch 84 which selects the power on the unit so that the batteries would not be depleted and further acts as a safety device. In the radio frequency embodiment, transmitter 80 sends signals from antenna 90 to receiver antenna 70 to convey the commands which may be desired. By using digital encoding which is known in wireless technology, one can be assured that stray radio frequency interference which may be present in industrial environments does not cause receiver 52 to be commanded to operate when it is not intended.

Another useful safety enhancement on receiver 52 is the application of audio emitter or beeper 78 integrated into the receiver. Receiver 52 includes an off switch 74 which allows the unit to be disabled and it conserves batteries. Receiver 52 also contains voltage condition lamp 76 which is a light emitting diode emitting a green light when the battery condition is good and switch 74 is on, and begins to blink red when the voltage falls to a level that requires replacement of the standard battery cells contained within receiver 52.

In the preferred embodiment, beeper 78 begins to “chirp” once every thirty seconds when power switch 74 is activated. The emitted “chirp” indicates to the users of the apparatus that the receiver is activated and ready for operation. It also has the effect of bringing attention to the location of hook 21 or hook 23 as it moves in its normal operation. The periodic chirping sound does not appreciably deplete the batteries. As a further safety enhancement, upon activation of the arming command by transmitter 80, a continuous tone can be emitted from beeper 78 such as to create a shrill warning tone providing notice that the hook is about to be or has been commanded to open and will be releasing its load shortly. It has been determined that such a safety feature is desirable in the operation of the present invention both as a safety feature and as positive feedback to the operator that a command to open the hook has been received by receiver 52.

Turning now to FIG. 8, a preferred embodiment of the present invention will be described. Wireless hook 23 is shown in plan view and in the closed position. In reviewing FIG. 8, it can be seen that hook 23 is similar to hook 21 in FIG. 2 except electric solenoid 50 is disposed within latch rotating arm 30 such as to eliminate the need for bolt release cable 38 as has been described in FIG. 1 and FIG. 2. By locating electric solenoid 50 in line with bolt 28, the connections between solenoid 50 and bolt 38 can be entirely within housing shroud 45 thereby eliminating any possibility that cable 38 could foul, collect dirt or debris, or otherwise be exposed to the elements.

It is necessary in the configuration shown that electrical power be conducted to solenoid 50 such that solenoid 50 can be activated when commanded to retract by the remote control. This can be accomplished through a conventional pair of conductors such as wire 72 shown in FIG. 8 which presents the activation voltage from unit 52 to solenoid 50 when there is a command signal to retract the solenoid and open arm 30. Although shown in the figures to be hanging free for clarity of illustration, wires 72 can be affixed to the housing of rotating arm 30 and should be provided enough slack in the connection such as to account for the movement of arm 30 as it is opened and closed during the operation of hook 23. Wire 72 can also be armored or protected by a flexible shroud material if desired. In operation of this embodiment, wire 72 is dressed close to the body of hook 23 and is secured by cable clamps or wire ties (not shown) along interior surfaces where possible.

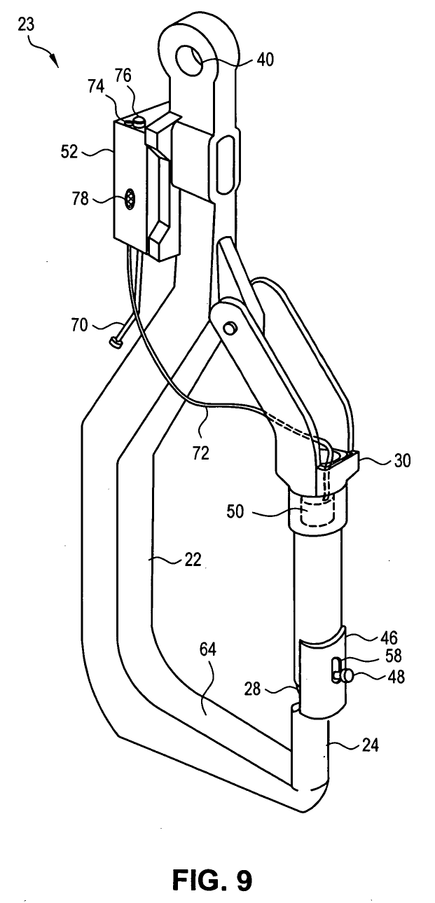

FIG. 9 also shows the preferred embodiment of FIG. 8 in a prospective view where the electric solenoid is contained within rotating arm 30. FIG. 9 presents an enhanced view of the various surfaces of the hook as used in the various embodiments described in the present disclosure. Also, the power switch 74 and battery indication light 76 contained on the top of receiver 52 is more clearly shown.

FIG. 8 and FIG. 9 both demonstrate simple additions to the alternate embodiment of safety crane hook 21. The on/off switch 74 of receiver 52 can conserve power. Receiver 52 is battery powered, and can operate with long life alkaline cells or rechargeable lead acid batteries which can be replaced from time to time or recharged as the case may be. Since most remote receiver devices do no require much current, conventional alkaline cells can be used in the receiver with good results.

To increase the life of the batteries, power switch 74 shuts down the receiver unit when the hook is not in service or when remote retraction of bolt 28 is not required, such as when only manual bolt retraction handle 48 is to be used. Likewise, it is useful to have a low battery indication as shown in lamp 76 as shown in FIG. 8 and FIG. 9. In this embodiment, a low battery condition lights lamp 76 in a red color, while a full voltage condition, indicating a serviceable battery and power is on, lamp 76 lights in a green color. It should be noted that even if a battery fails when in service, safety is not compromised because the receiver 52 operates in essentially a fail-safe mode. This is because with no battery to operate the receiver, rotating arm 30 remains closed as there can be no retraction of the solenoid 50 if receiver 52 is not operating or otherwise does not have sufficient power to cause activation of solenoid 50 to retract bolt 28. In such an occurrence it is a simple matter to lower the hook to either replace the batteries within 52 or to release the load being lifted by using manual retraction handle 48 as shown on the various drawings. When using a rechargeable type of battery, it would be a simple matter to utilize a power recharging jack on receiver unit 52 such as to insert a low voltage recharging cord to allow any rechargeable batteries to recharge over a suitable period of time as the case may be. In most operating environments, it has been determined that disposable non-rechargeable batteries are more convenient and provide several days of operation, assuming about two hundred release activations per day.

Another variation of the disclosed invention may include means to cause rotation of arm 30 by power driven means rather than spring 34, or a counterweight to create rotation of arm 30 gravity. It would be possible to replace spring 34 with a power driven rotational solenoid or motor device which would operate to rotate arm 30 in an open and closed position upon remote command. Depending on the device used to replace spring 34, it is possible to integrate the control signal to power such a device to be coordinated with the retraction of bolt 28, thereby allowing a remote control embodiment of the present invention to open and close the hook safety mechanism under electrical power, as opposed to a combination of the electrical power with the retracting solenoid and the coil spring providing the rotational force to open arm 30. However, it should be appreciated that such a more complex design would require more battery capacity, and necessarily adds another failure mode to an otherwise simple design, as shown in the preferred embodiment.

The preferred embodiment shown in FIG. 8 and FIG. 9 operate with solenoid 50 internally disposed within rotating arm 30. Moreover, it has been determined that it is possible, in fact desirable, to attach solenoid 50 directly to bolt 28 without the need for a cable. Depending on the design of solenoid 50, it could be appreciated by those familiar with solenoids which operate by linearly retracting or extending that the solenoid arm can be connected directly to the top edge of retracting bolt 28 such as to eliminate the need for spring 36. It has been determined in operation that bolt 28 will retract and extend cleanly without spring 36 used to drive the bolt closed when the solenoid power is released. Solenoid 50 can have an internal spring and return mechanism which itself drives bolt 28 downward when the power to the solenoid is discontinued. In such a case, it is desirable to have the solenoid directly connected to the bolt without a flexible cable or other connecting member that may not properly transmit the linear motion of a solenoid to the bolt. Regardless of the operation, spring 36 may be used in some installations where solenoid 50 is not of a sufficient design or type to briskly move the bolt into position. Such modifications clearly depend on the type of solenoid used to drive the action of bolt 28.

Thus has been described a new and improved crane hook with an integrated safety latch in accordance with the present invention. The various exemplary embodiments, along with the details in the figures attached, described how to make and use the invention. Other variations will occur to those skilled in the art of designing and/or using such implements. The thrust of the invention is described above, being the simple safety catch and release mechanism which rotates to an open position automatically upon the execution of a command signal, either through tension on a manual cord, or transmission of a signal through electronic means. All variations of the invention so described herewith which are within the scope and intent of the disclosure in operation of the invention are intended to be included as variations of the invention which still operate and function within the spirit and scope of the present disclosure.

1. A hook of the type used in lifting loads comprising:
a load lifting frame for engaging a load within the frame;
a throat area existing between the open portion of the frame for engaging the load to be lifted;
attachment means to attach the frame to lifting apparatus;
a latch attached to said frame to selectively restrict the disengagement of the said load; and
a means to disengage said latch from a location remote from the hook.

2. A load bearing lift apparatus comprising:
a hook which includes an open portion of the hook structure for attaching to a load;
a latching means disposed to selectively secure said open portion of the hook structure;
a mechanism for securing said latching means to the body of said hook when said latching means is in a secured position;
retraction means to release said mechanism for securing said latch.

3. A hook of the type which is used to lift loads and is comprised of a hook body which can attach to a load through the throat of said hook body, an improvement comprised of a movable member which selectively closes the throat of said hook, wherein further said movable member includes a remotely retractable closing mechanism which secures the movable member when the said member closes said throat of the hook and said member opens the throat of said hook upon command.

4. Apparatus for securing a load to be lifted including:
a hook which attaches to load lifting machinery and is comprised of an open portion of said hook to engage a load to be lifted;
means to selectively secure said open portion of said hook to prevent the engaged load from disengaging from the hook;
means to control said means to selectively secure said open portion of said hook to unsecure said open portion of said hook from a location remote from the location of the hook upon activation of said means.

5. A method of securing a load on a hook comprising:
affixing the load to the hook through the throat of the hook;
securing the load to the hook by activating a latching means over the throat after affixing the load;
conveying the load to a desired location; and,
unsecuring the load by deactivation of said latching means from a location remote from the hook.

6. The hook of claim 1 wherein further said latch is comprised of a member attached to the load lifting frame at one end of said member to rotate about said attached end upon activation of said means to disengage said latch.

7. The hook of claim 6, wherein further said means to disengage said latch is comprised of a moveable bolt to secure the end of said member opposite the end of said member upon which said member rotates.

8. The hook of claim 7, further including means to retract said bolt to selectively disengage said latch which is comprised of a cable attached to said bolt and disposed to present said cable to a location remote from said hook to selectively activate said bolt to disengage said latch.

9. The hook of claim 7, wherein said means to selectively disengage said latch from a remote location is comprised of a wireless transmitter means and receiver means to control said moveable bolt upon command.
